(19) United States
(12) Patent Application Publication
(10) Pub. No.: US 2007/0000604 A1
(43) Pub. Date: Jan. 4, 2007

(54) METHOD OF MANUFACTURING DECORATIVE LAMINATE

(76) Inventor: Thomas E. Lyon, Lawton, MI (US)

Correspondence Address: KANE & CO., PLC, 210 Commerce Building, 6 Lyon St. N.W., GRAND RAPIDS, MI, 49503, US

(21) Appl. No.: 11/307,187

(22) Filed: Sep. 18, 2006

Related U.S. Application Data
(60) Provisional application No. 60/593,588, filed on Jan. 27, 2005.

(51) Int. Cl. B32B 37/00

(52) U.S. Cl. 156/293

(57) ABSTRACT

A method for manufacturing a unique laminate sheet is disclosed herein including attaching at least one and preferably two or more sheets of laminate having a predetermined shape to a backer sheet using an adhesive. A protective sheet overlies the nested sheets of laminate attached to the backer sheet until such time as the assembly is applied to the predetermined surface.

### BACKGROUND OF THE INVENTION

The invention relates generally to laminate sheeting, and particularly to a method for manufacturing a decorative laminate sheet.

Decorative laminate sheeting has historically been manufactured by bonding a plurality of layers or sheets of paper together with an adhesive under high pressure. The upper or exposed surface of the laminate sheeting typically contains a decorative color or pattern. The final or overlying layer generally consists of a thermo-set or thermo-fixed polymeric layer protecting the underlying artwork or design while also making it viewable by the naked eye. Historically this method has been employed in the mass production of laminate sheeting to provide uniform and low cost surfacing material. The disadvantage associated with the current manufacturing method is it is very expensive to manufacture single sheets containing a custom design.

As a consequence custom patterns or designs are created by hand on the surface of the laminate using paints or other media. The custom design or artwork was then protected by an overlying coat of a lacquer or similar coating. The disadvantage associated with this system is that the coating often times was not as durable as the laminate surface itself. Moreover it was not at all unusual for the lacquer or clear coating to become separated from the top of the laminate because of flexing and the inherently poor bond that was achieved between the laminate surface and the polymeric coating. Moreover the resulting finish of a protective liquid coating over the top of the laminate was dissimilar to the finish produced on the adjoining laminate surfaces and thus not as visually appealing as if the entire surface had a consistent lustre.

### SUMMARY OF THE INVENTION

A method for manufacturing a decorative laminate sheet is disclosed including the step of forming a first sheet of laminate in a predetermined shape; cutting a substantially similar shaped cavity in at least a second sheet of laminate, and nesting the shaped first sheet of laminate in the cavity shaped in the second sheet. In a further form of the invention the method includes bonding the first and the second sheet to a backer material to provide a common substrate. In yet another form of the invention the method may include bonding a third sheet or layer over the nested sheets of laminate to provide a transparent protective layer.

In yet another form of the invention a custom decorative sheet of laminate is provided including a first sheet having a predetermined outer peripheral shape, a second sheet having a cavity formed therein wherein at least a portion of an inside perimeter of the cavity is shaped to substantially conform to at least a portion of the outer peripheral shape of the first sheet. A third sheet is provided as a common substrate for supporting both the first and the second sheet of material. In yet another form of the invention a protective or transparent coating or layer may be disposed on top of the first and second sheets.

The advantages offered by both the method and the assembly of the instant invention include the ability to provide a custom design using traditional laminate materials that can be matched with the same material used in the application. These and other advantages will become readily apparent to those skilled in the art when taken in consideration with the following detailed description and appended drawing figures.

### BRIEF DESCRIPTION OF THE DRAWING FIGURES

FIG. 1 is an exploded view of one embodiment of the invention; and

FIG. 2 is a perspective view of the completed assembly with the cover sheet removed.

### DETAILED DESCRIPTION OF THE INVENTION

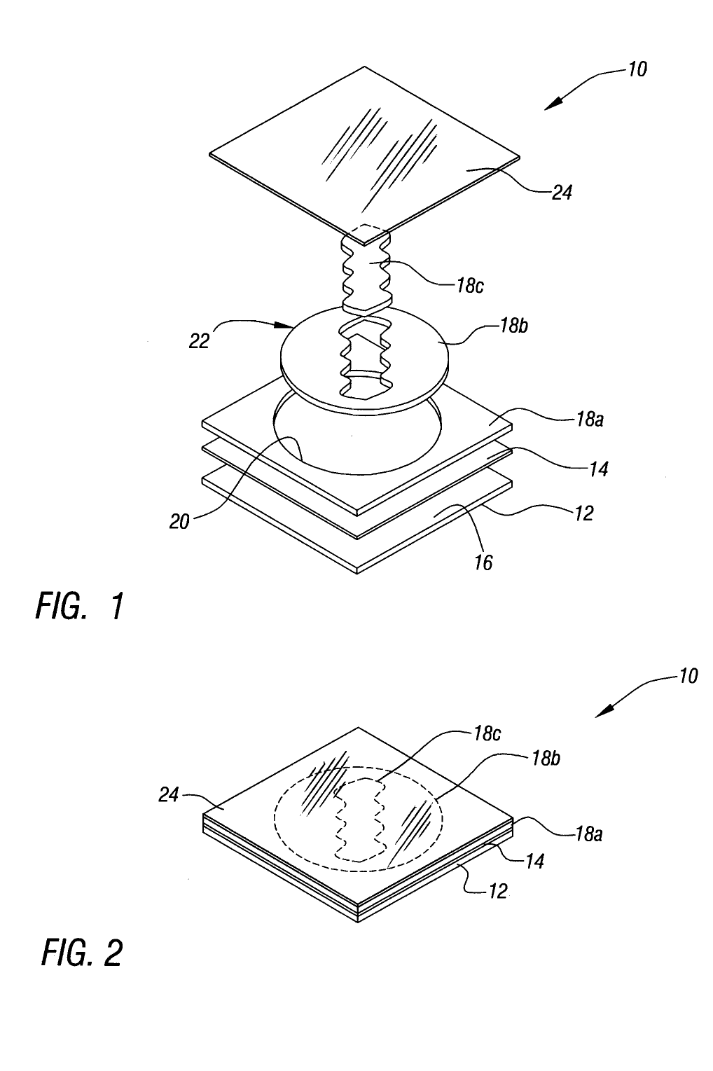

FIGS. 1 and 2 generally illustrate the basic components comprising the invention. In one embodiment 10, the invention includes a backer sheet or other suitable material 12 for providing a common bonding substrate. The bonding material may be provided by at least one layer of adhesive 14 applied to the bonding surface 16 of the backer sheet 12. Attached to the bonding surface 16 of the backer sheet 12 by the adhesive 14 is at least one, and preferably two or more sheets of laminate 18. In a preferred embodiment of the invention, a first sheet of laminate 18a is cut to provide a cavity of predetermined inside peripheral form or shape 20. As might be expected the peripheral cavity 20 inside sheet 18a comprises the outline of the custom design. To complete the custom decorative design, at least a second sheet of laminate 18b is provided wherein at least a portion of the exterior peripheral shape 22 substantially matches at least a portion of the interior peripheral shape 20. The second sheet of laminate 18b is located adjacent the matching profile in the interior shape 20 and fixed in location by the adhesive 14 bonding with the backer sheet 12. To complete the decorative feature or design of the invention, additional sheets 18c having predetermined shapes may be nested and bonded within the interior peripheral shape 20.

To protect the decorative feature of the invention and to keep the respective laminate sheets in position before final location, a protective cover layer or coating 24 may be placed over the upper surfaces of the first, second, and subsequent sheets within the interior peripheral shape 20. In a preferred embodiment of the invention the adhesive used for bonding the protective cover or layer 24 is sufficiently tacky to keep the respective sheets 18 in place, yet easily removable once the entire sheet assembly 10 is firmly bonded in its final location. In the same vane it is envisioned that the adhesive layer 14 bonding the different laminate sheets to the backer sheet 12 is also sufficiently tacky to maintain the relative positioning of the different laminate sheets 18 until the entire assembly 10 is fixed in its final location. Alternatively the backer sheet 12 may be permanently attached to the various components depending in substantial part on the desire of the operator or builder.

The number of laminate sheets 18 may vary, depending in large part upon the complexity of any design or pattern to be produced. The patterns or outlines defined by the respective sheets 18 are bonded by the adhesive 14 to the backer sheet 12 to create a single laminate sheet assembly 10. Once the various laminate sheets 18 are bonded to the backer sheet 12, the protective cover sheet 24 may be applied to protect the upper surface from marring or other damage and to keep the respective positions of the sheets. In this configuration the invention allows the end user to install the sheet assembly 10 using conventional methods and materials for bonding laminate to surfaces. As mentioned above, the cover sheet 24 may be peeled off after the plastic laminate sheet assembly is bonded to the substrate.

FIG. 2 is a simple schematic diagram illustrating how in one embodiment the different pieces of the invention 10 may be assembled into a single layer. The invention provides a method for creating unique designs from the plastic laminate for use on tables, counters, and other surfaces typically covered in plastic laminate. By creating a single sheet of nested plastic laminate pieces 10 the invention creates the opportunity for plastic laminate installers to use nested laminate designs in new and novel applications for their business.

In general, the artwork or design will be cut into precision individual pieces 18a, 18b, etc. from plastic laminate. The preferred tools for completing the cutting of the individual components is a computer numerically controlled (CNC) cutting machine containing rotary, liquid or laser cutting heads. In particular it is envisioned that a typical x-y table containing a traversing cutting tool can be used to implement the invention. It is also envisioned that a more complex articulated CNC device may be used wherein cutting in the Z-direction may also be used. These automated cutting devices can quickly and easily cut the appropriate pattern with a high degree of accuracy and close tolerance.

Using the equipment described above the operator converts or otherwise places the artwork or design into suitable computer language used to carryout the cutting instruction. From this computer language the particular design or image is converted into suitable machine control commands used to control the motion of the CNC cutting machine. High precision is required to create the appearance of a contiguous if not seamless sheet of plastic laminate. It is important esthetically that close tolerances be maintained so that the different pieces of laminate nest together along their margins so as not to create any significant gaps or spaces which would detract from the appearance of the design. Without the protective cover 24 such gaps and irregularities between respective components or sheets leave a discernable boundary between the different components. But with the instant method of making these decorative sheets, tolerances are sufficiently close that it appears the design is formed from a single laminate sheet. The protective cover sheet provides additional strength to the different pieces to prevent cracking of the plastic laminate pieces or separation of the joints during handling. The cover sheet also provides additional stiffness to facilitate installation and protects against scratches on the decorative surface.

Once the different sheets 18 are suitable for bonding, the adhesive 14 is applied to the backer sheet 12 and to the back of the decorative plastic laminate pieces 18. The individual pieces 18 are placed on the backer sheet 12. Masking tape or some other material may be used to hold the individual pieces 18 together while the adhesive sets. The assembly 10 may then be placed in a suitable press such that compressive force may be applied for a specified period of time to complete the bond. Once the adhesive cures the assembly can be installed onto a substrate using conventional methods of installation. Many plastic-laminate installers prefer to use a contact-cement for bonding the plastic laminate to a substrate. The contact cement may be spread on the plastic laminate and substrate in a number of techniques, with the overall goal to obtain a generally uniform and sufficient layer to form a good bond. The contact cement substantially bonds instantly when the two pieces make contact. Repositioning of the pieces is nearly impossible once contact has been made. Using this type of assembly method does not allow the individual pieces to be repositioned to form a gap free appearance. The invention allows the use of contact cement for the final installation of assembled plastic laminate pieces. Alternatively, the adhesive 14 may also be lightly cured or of sufficient light bonding to temporarily hold the different components 18 to the backer sheet 12 until such time as the backer sheet 12 is removed for final bonding.

The invention also has the advantage that the complexity and number of nesting pieces does not increase the effort needed to install the single assembled sheet. These and other modifications may become readily apparent to one of ordinary skill in the art but consistent with the overall tenet of my method. The foregoing is not intended to limit or disclaim any feature of the invention unless expressly stated above.

What is claimed is:

1. A method for manufacturing a laminate sheet, including the step of nesting a first sheet of laminate having a predetermined shape within a cavity formed in a second sheet of laminate to accommodate said predetermined shape of said first sheet of laminate.

2. A laminate sheet assembly, comprising: a first sheet of laminate having a predetermined outer periphery shape; a second sheet of laminate having a cavity formed therein and having an inner periphery shape formed to accommodate said first sheet of laminate.

3. The laminate sheet assembly as defined in claim 2, wherein said first and second sheets of laminate are bonded to a backer sheet.

4. The laminate sheet assembly as defined in claim 3, further comprising a protective cover applied to a first side of said first and second sheets of laminate.

5. The laminate sheet assembly as defined in claim 3, wherein said backer sheet receives an adhesive for bonding said backer sheet to a predetermined substrate.
